(19) United States
(12) Patent Application Publication
(10) Pub. No.: US 2005/0172841 A1
(43) Pub. Date: Aug. 11, 2005

(54) Rotary press

(76) Inventor: Tetsuyuki Goto, Mihara-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/839,279

(22) Filed: May 6, 2004

(30) Foreign Application Priority Data
May 12, 2003 (JP) 2003-133734

(51) Int. Cl. B41F 13/06

(52) U.S. Cl. 101/227

(57) ABSTRACT

A rotary press facilitating a change-over to multiple web widths is provided. The rotary press comprising plural feeding parts supplying a web, plural printing parts printing the web and a folding part folding the web further comprises a turn bar changing a running direction of the web before the web sent from the printing parts enters the folding part and plural triangular formers leading the web to the folding part. By selecting the turn bar or adjusting a position of the turn bar, the web having various web widths can be appropriately led onto the triangular formers.

### BACKGROUND OF THE INVENTION

1. Field of the Invention

The present invention relates to a rotary press performing printing corresponding to various web widths.

2. Description of the Prior Art

In printing newspapers, in order to efficiently perform the printing of newspapers that are published every day, such a news rotary press as exclusively designed and manufactured therefor is used.

A first example of a prior art news rotary press will be described with reference to FIGS. 8 to 14. FIG. 8 is a plan view seen from above of this prior art news rotary press that corresponds to all-web width or every size of a web width. FIG. 9 is a front view of the news rotary press of FIG. 8 and FIG. 10 is a side view of a folding part of the news rotary press of FIG. 8 as seen in the direction of arrow X of FIG. 9.

In FIGS. 8 and 9, a feeding part 1a, 1b, printing part 2a, 2b and folding part 3 are arranged in one row so that a web can run straight. It is to be noted that while the feeding part 1 and printing part 2 are usually provided in the number of plurality according to the need, description here will be made with respect to an example of two rows.

A web 5a, 5b unwound from a paper roll 4a, 4b fitted to the feeding part 1a, 1b is fed to the printing part 2a, 2b and has its web both sides printed by a plate cylinder 6 and blanket cylinder 7. The printed web 5a, 5b is sent to the folding part 3. Immediately before entering the folding part 3, the web 5a, 5b has its web width center cut along the running direction by a slitter 8 above a drag roller 9. Another drag roller 11 is provided above a triangular former 10a, 10b and an abutting roller 12 is arranged detachably to the drag roller 11. The web 5a, 5b, while being pinched between the drag roller 11 and abutting roller 12, is sent to the respective triangular former 10a, 10b by rotation of the drag roller 11 to be thereby folded along the running direction. In the folding part 3, the web 5a, 5b is cut and folded rectangularly to the running direction and then discharged in the arrow direction shown in FIG. 8.

Further, a second example of a prior art news rotary press will be described with reference to FIGS. 15 and 16. FIG. 15 is a plan view of this prior art news rotary press and FIG. 16 is a front view of the news rotary press of FIG. 15.

A plurality of feeding parts 1 are arranged in an axial direction of a paper roll 4 and a plurality of black printing units 24 corresponding one to one to the feeding parts 1 and one folding part 3 are arranged in parallel with the axial direction of the paper roll 4. On the opposite side of each of the feeding parts 1 relative to the position of each of the black printing units 24, a multi-color printing unit 25 corresponding to at least one of the black printing units 24 is arranged in the axial direction of the paper roll 4. A web 5 coming out of the black printing units 24 and the multi-color printing unit 25 is cut into the half size (two pages) and a running direction of the web is changed by an angle of 90° by a moving turn bar 26 provided above the multi-color printing unit 25 so that the web 5 is led further to the folding part 3.

By this construction, the news rotary press can be made compact, spoilage (loss of paper) at the time of color adjustment of the multi-color printing can be lessened and operation efficiency of the rotary press can be enhanced. Also, by the moving turn bar provided between the feeding parts and the multi-color printing unit, a multi-color portion can be easily inserted into a position specified by the editing, as described in the Japanese Utility Model laid-open application Hei 3-70934 for example.

In such news printing, the size of the page is decided and the web width corresponding to each rotary press is also decided. The web width is usually such a width as having 4 pages in the width direction. If a page layout is to be changed so that the web width is changed, such a web width as having 3 pages in the width direction as shown in FIG. 12 or 2 pages in the width direction as shown in FIG. 13 is often employed. In this case, the arrangement position of the web in the 3-page width or 2-page width can be variously set other than the patterns as illustrated in FIGS. 12 and 13.

Here, with reference to FIGS. 11 to 14, a position relation between a plate cylinder, slitter cutting the web along the running direction of the web and triangular former in the case of the news printing will be described. FIG. 11 is an explanatory view showing the position relation in the case of a prior art news printing of a standard web width (all-web width), FIG. 12 is an explanatory view showing the position relation in the case where a prior art news printing of a ¾ web width is carried out by an upper portion of the illustration of FIG. 12, FIG. 13 is an explanatory view showing the position relation in the case where a prior art news printing of a half web width is carried out by an upper half portion of the illustration of FIG. 13 and FIG. 14 is an explanatory view showing a position relation between a plate cylinder, slitter and triangular former in the case where a prior art printing of a non-standard web width (a web width narrower than a one-page width, for example) is carried out.

A width directional position of the web 5a, 5b is decided by a position of a plate 21 of the plate cylinder. Even if the web width is changed, the page position of the web 5a, 5b is fixed relative to the folding part 3. The position of the triangular former 10a, 10b in the folding part 3 is also arranged symmetrically relative to the center of the folding part 3 so as to correspond to the position of the folding line 13, 14 of the page. Also, the slitter 8 for cutting the web 5a, 5b along the longitudinal direction or the running direction of the web 5a, 5b is arranged at a position corresponding to the page. Moreover, the abutting roller 12 for sending the web 5a, 5b to the folding part 3 is needed to abut on and push a non-printed portion (of both ends of each page) of the web 5a, 5b.

However, in case where printing of a non-standard web width other than the news printing is to be carried out by this news rotary press, it is necessary that webs having various web widths are printed, folded and discharged differently from the printing of the standard web width. In this case, the position of the triangular former 10a, 10b is to be changed corresponding to the change of the position of the folding line 13, 14.

Thus, as the triangular former 10a, 10b must be of such a size as corresponds to the standard web width, the triangular former is arranged such that the apexes 23a, 23b of the two triangular formers 10a, 10b accord with the folding lines 14, 13. In case of the non-standard web width shown in FIG. 14, in order to arrange the triangular former so that the apexes 23a, 23b of the two triangular formers 10a, 10b accord with the folding lines 14, 13, the two triangular formers 10a, 10b must approach to each other so that central side portions 15 of the triangular formers 10a, 10b will be lapped one on the other. Hence, the central side portions 15 that are lapped one on the other are made by detachable exchange parts 16a, 16b and thereby the triangular formers 10a, 10b can be approached to each other so that the central side portions 15 are not lapped one on the other. Several kinds of these exchange parts 16a, 16b are prepared corresponding to the web widths and are exchanged so as to meet the various widths of the web 5a, 5b.

If the web width is changed as mentioned above, it is necessary that the position of the triangular former is moved corresponding to the difference of the web width. That is, in each case where the standard news printing is changed over to the non-standard web width printing and also in the reverse case thereof, position adjustment of the abutting roller 12 other than the abutting roller 12a, 12b that exists at least on the central position of the rotary press, position adjustment of the two triangular formers 10a, 10b and attachment and detachment of the exchange parts 16a, 16b at the time of interference of the triangular formers become necessary and a long working time is needed for change-over of the web width.

Also, if the change-over work is to be automated, there are many places to be automated such that movement of the triangular former 10a, 10b and the abutting roller 12 on the drag roller 11 other than the abutting roller 12a, 12b is automatically adjusted to be appropriately positioned and hence the structure of the rotary press becomes complicated and expensive.

Moreover, in the news printing, especially in the case of printing the non-standard web width, there are many folding structures and the printed web is often differently allotted to the triangular former 10a or 10b. That is, if the example of FIG. 11 is taken, by leading the web on a plane A, B of the printing part to the triangular former 10a or, reversely, by leading the web on a plane B, C to the triangular former 10b, the aimed position change is achieved. For this purpose, however, many other turn bar devices are needed and this requires a large space and high cost of the rotary press.

Further, it will be the largest problem if operation condition and operation state of the news printing, that is a main field of the rotary press and requires a large quantity and high speed of printing, are obstructed. In the news printing in which the latest news must be printed and supplied up to a specified time every day, it is a matter of course that obstruction of the news printing due to printing of the non-main field (printing of the non-standard web width, for example) must be avoided. Hence, in order to realize a rotary press that is able to correspond to various printing patterns and operation conditions of the recent non-standard printing, it is necessary to enhance the operability of each of the devices of the rotary press from the feeding part to the folding part so that the machine can be easily controlled by less number of operators.

### SUMMARY OF THE INVENTION

In view of the above-mentioned problems in the prior art rotary press, it is an object of the present invention to provide a rotary press in which arrangement of each constructing part of the rotary press is devised so as to solve the above-mentioned problems.

In order to achieve the above object, the present invention of claim 1 is characterized in that, in a rotary press comprising a plurality of feeding parts supplying a web from a paper roll, a plurality of printing parts printing the web sent from the feeding parts and a folding part folding the web sent from the printing parts, the rotary press further comprises a slitter cutting the web along a running direction of the web, a turn bar changing the running direction of the web before the web sent from the printing parts enters the folding part and a plurality of triangular formers leading the web to the folding part and the turn bar is selected corresponding to a web width to be printed or a position of the turn bar is adjusted relative to the triangular formers.

According to the construction mentioned above, the position adjustment of the turn bar is carried out and thereby webs having various web widths can be led to an arbitrary triangular former, a change-over work from a standard news printing to a non-standard printing can be easily done and the time required for the change-over can be greatly reduced.

Also, in order to achieve the above object, the present invention of claim 2 is characterized in that, in the rotary press as mentioned in claim 1, the turn bar comprises a turn bar corresponding to an all-web width and at least one turn bar corresponding to a web width narrower than the all-web width.

According to the construction mentioned above, an optimal turn bar can be selected corresponding to the web width of the news printing and printing other than the news printing so that the web is appropriately led to the triangular former and thereby the change-over from the non-standard printing to the standard news printing can be easily done. That is, without damaging the efficiency required for the news printing, various non-standard web widths can be printed and also the change-over work can be easily automated. Thus, equipment cost of the rotary press can be reduced and enhancement of the printing efficiency can be realized.

Also, in order to achieve the above object, the present invention of claim 3 is characterized in that, in the rotary press as mentioned in claim 1 or 2, the feeding parts and the printing parts are arranged along the running direction of the web, the folding part is arranged in parallel with an axial direction of the paper roll in the feeding parts and the turn bar is provided between the printing parts and the folding part so that the running direction of the web is changed by an angle of 90° or approximately 90°.

According to the construction mentioned above, the working time and workers required for the change-over of the web width can be reduced and the operability can be enhanced. Also, a high speed large size rotary press that is able to correspond to various web widths can be realized.

Also, in order to achieve the above object, the present invention of claim 4 is characterized in that, in the rotary press as mentioned in claim 1 or 2, the feeding parts are arranged on the same floor as the printing parts and/or the folding part and the turn bar is arranged above the printing parts arranged in parallel with an axial direction of the paper roll corresponding to the feeding parts so that the running direction of the web is changed by an angle of 90° or approximately 90°.

According to the construction mentioned above, the change-over work of the web width can be done on the same floor and thereby the working time and workers required for the change-over can be greatly reduced and the operability can be enhanced. Also, a high speed large size rotary press that is able to correspond to various web widths can be realized.

### BRIEF DESCRIPTION OF THE DRAWINGS

FIG. 1 is a plan view of a news rotary press of a first embodiment according to the present invention.

FIG. 2 is a front view of the rotary press of FIG. 1.

FIG. 3 is an explanatory view showing a position relation of a plate of a plate cylinder, slitter, turn bar, abutting roller and triangular former in the case where a web width different from a standard width is printed by the rotary press of FIG. 1.

FIG. 4 is an explanatory view showing a position relation of a plate of a plate cylinder, slitter, turn bar, abutting roller and triangular former in the case where a standard web width is printed by the rotary press of FIG. 1.

FIG. 5 is a plan view of a news rotary press of a second embodiment according to the present invention.

FIG. 6 is a front view of the rotary press of FIG. 5.

FIG. 7 is a side view of the rotary press of FIG. 5.

FIG. 8 is a plan view of a first example of a prior art news rotary press arranged in one row.

FIG. 9 is a front view of the rotary press of FIG. 8.

FIG. 10 is a view seen in the direction of arrow X of FIG. 9.

FIG. 11 is an explanatory view showing a position relation of a plate, slitter and triangular former in the case of a prior art news printing of a standard all-web width.

FIG. 12 is an explanatory view showing a position relation of a plate, slitter and triangular former in the case of a prior art news printing of a ¾ web width.

FIG. 13 is an explanatory view showing a position relation of a plate, slitter and triangular former in the case of a prior art news printing of a half web width.

FIG. 14 is an explanatory view showing a position relation of a plate, slitter and triangular former in the case of a prior art printing of a non-standard web width.

FIG. 15 is a plan view of a second example of a prior art news rotary press.

FIG. 16 is a front view of the rotary press of FIG. 15.

### DESCRIPTION OF THE PREFERRED EMBODIMENTS

### First Embodiment

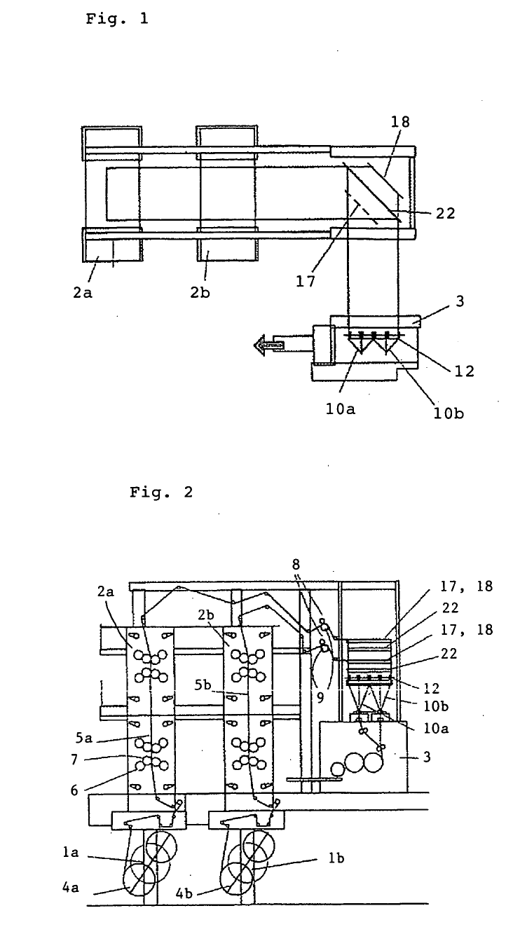

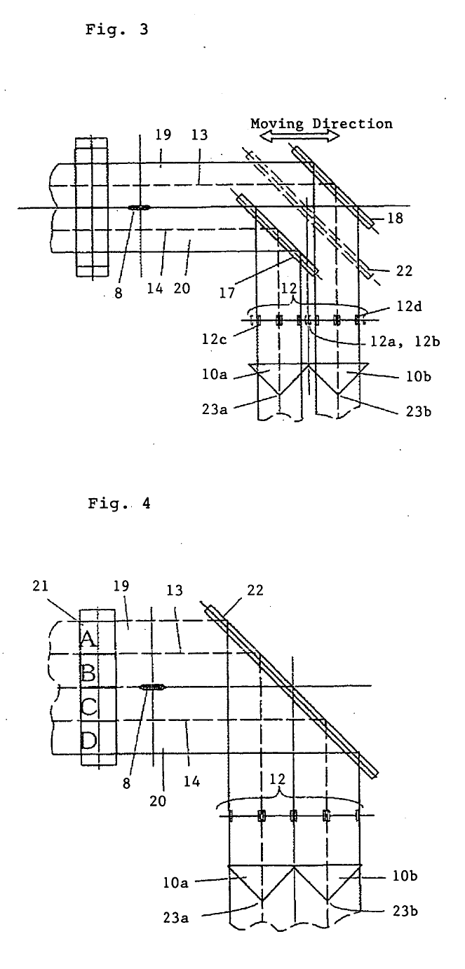

A rotary press of a first embodiment according to the present invention will be described with reference to FIGS. 1 to 4. FIG. 1 is a plan view seen from above of a rotary press of one row and FIG. 2 is a front view of the rotary press of FIG. 1. Also, FIG. 3 is an explanatory view showing a position relation of a plate of a plate cylinder, slitter, turn bar, abutting roller and triangular former in the case where a web having a web width different from a standard width (non-news web width) is printed by the rotary press of FIG. 1. FIG. 4 is an explanatory view showing a position relation of a plate of a plate cylinder, slitter, turn bar, abutting roller and triangular former in the case where a web having a standard web width (news web width) is printed by the rotary press of FIG. 1. It is to be noted that, unless otherwise specifically defined, the size, material, shape, relative position, etc. of constructing parts and components of the embodiments according to the present invention are shown only for the purpose of exemplification and the scope of the present invention is not limited to those illustrated and described herein. Also, the parts and components same as the above-mentioned prior art ones are designated with the same reference numerals and repeated description thereon will be omitted.

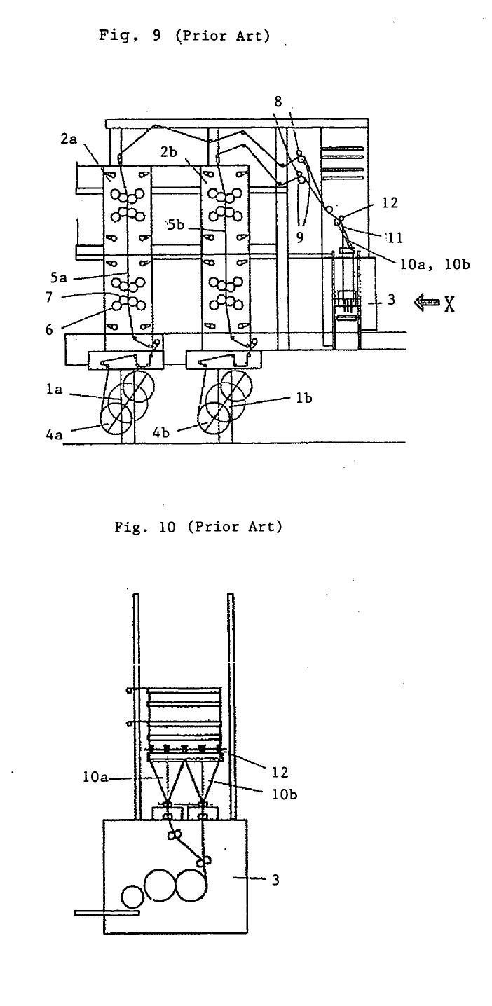

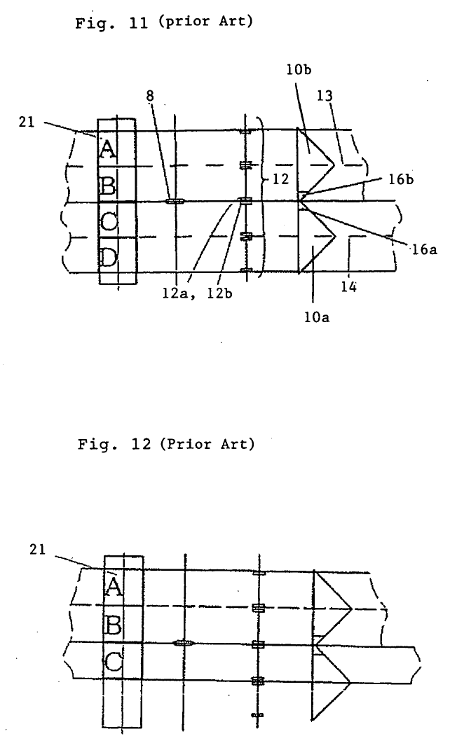

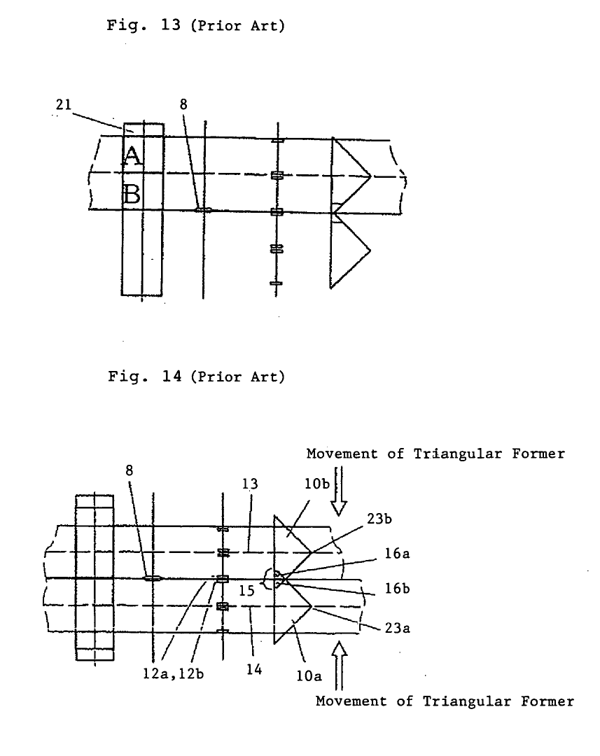

In FIGS. 1 and 2, the feeding part 1a, 1b that supplies the web 5a, 5b from the paper roll 4a, 4b and the printing part 2a, 2b that performs printing of the web 5a, 5b sent from the feeding part 1a, 1b are arranged in one row, like in the first example of the prior art news rotary press shown in FIGS. 8 to 10, so that the web 5a, 5b runs straight before it enters the folding part 3. The folding part 3 that folds the web 5a, 5b sent from the printing part 2a, 2b is of the same construction as the mentioned prior art case and is arranged in parallel with an axial direction of the paper roll 4a, 4b of the feeding part 1a, 1b. The printed object, after folded, is discharged in the arrow direction shown in FIG. 1.

While the web 5a, 5b sent from the printing part 2a, 2b runs toward the folding part 3, it is necessary that the running direction of the web 5a, 5b is turned by an angle of 90° or approximately 90°. For this purpose, between the printing part 2a, 2b and the folding part 3, as shown in FIG. 3, a set of two turn bars 17, 18 is arranged for one web. The position of the turn bars 17, 18 is adjustable by an adjusting device (not shown) in the moving direction shown by arrows in FIG. 3 so that folding lines 14, 13 of the centers of two split webs 19, 20 accord with apexes 23a, 23b, respectively, of the triangular former 10a, 10b. Also, in case of the web for a standard news printing, a turn bar 22 made exclusively therefor is provided at a web path position separate from the turn bars 17, 18.

A case where printing is done on a web having a non-standard narrow web width will be described with reference to FIGS. 2 and 3. The relation between the feeding part 1a, 1b and the printing part 2a, 2b is the same as in the prior art case. Also, even in the case of changing the web width, like in the prior art case, the web runs so that the center of the web width accords with the center line of the machine. The printed web 5a, 5b is cut along the running direction by the slitter 8 on the drag roller 9 by the same method as the prior art case. The running direction of the split webs 19, 20 is changed rectangularly by the turn bars 18, 17, respectively, so that the folding line 13 of the web 19 accords with the apex 23b of the triangular former 10b and the folding line 14 of the web 20 with the apex 23a of the web 10a. Thus, while the position of the triangular former 10a, 10b that leads the web 19, 20 to the folding part 3 is kept fixed, a necessary folding can be achieved.

In case of the news printing, both of the two webs 19, 20 are turned by the exclusive turn bar 22 that is on a reference position. The turn bar 22 has a length corresponding to all the standard web widths, as shown in FIG. 4. In case of a web having a non-standard narrow web width, the turn bar 17, 18 is arranged at a web path position separate from the turn bar 22. The triangular former 10a, 10b is on the position that the folding line 13, 14 of the web 19, 20 accords with the apex 23a, 23b of the triangular former 10a, 10b and no adjustment corresponding to the change of web width is needed.

As is clear from the above description, in case where the web width is to be changed from the news printing to the non-standard printing other than the news printing, the parts of which position change is needed are four abutting rollers 12a, 12b, 12c and 12d out of the abutting roller 12 on the drag roller 11 above the triangular former 10a, 10b and by moving these rollers, the position adjustment of the turn bar 17, 18 can be done. In case where the non-standard printing is to be changed to the news printing, only by moving the above-mentioned four abutting rollers, the web can run on the web path realized by the turn bar 22.

Also, in the news printing, by using the turn bar 17, 18, that is, for example, by moving the turn bar 17 to the position on which the folding line 14 of the web 20 accords with the apex 23b of the triangular former 10b, the web 20 can be led to the triangular former 10b. That is, in the standard news printing (of the web width of 4 pages, 3 pages, 2 pages or 1 page) or in the non-standard printing, the turn bar 17, 18 or the exclusive turn bar 22 is appropriately selected and the position of the turn bar 17, 18 is appropriately adjusted, if needed, and thereby the web can be led to an arbitrary triangular former 10. Thus, if a turn bar corresponding to the all-web width and at least one turn bar corresponding to the web width narrower than the all-web width are provided, all the printing, even in the case of the standard news printing or even in the case of printing of the non-standard web width, can be satisfied. It is to be noted that the number of the turn bars may be the same number as the triangular formers or plus one thereof.

### Second Embodiment

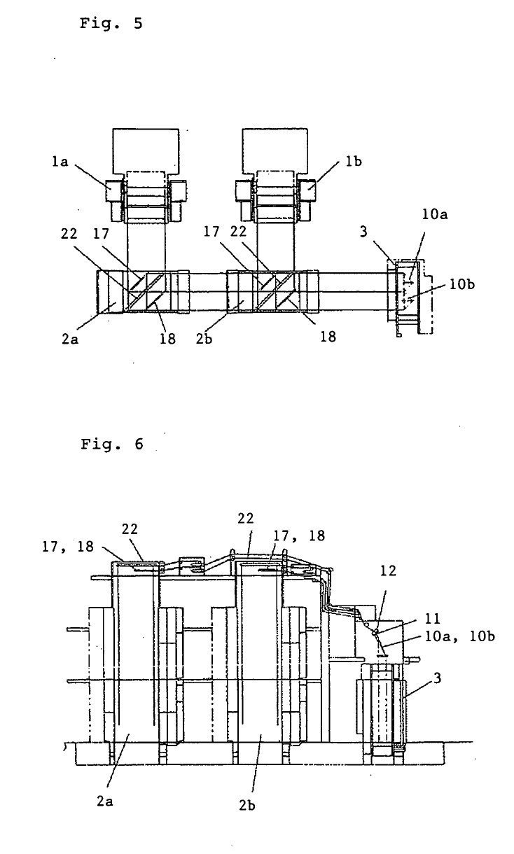

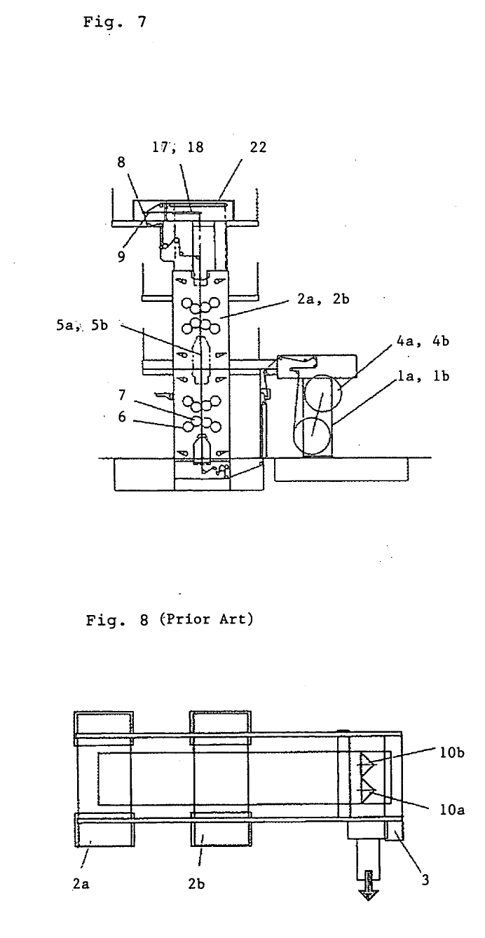

A rotary press of a second embodiment according to the present invention will be described with reference to FIGS. 5 to 7. FIG. 5 is a plan view seen from above of this rotary press, FIG. 6 is a front view of the rotary press of FIG. 5 and FIG. 7 is a side view of the rotary press of FIG. 5. It is to be noted that the parts and components same as those of the above-described first embodiment are designated with the same reference numerals and repeated description thereon will be omitted.

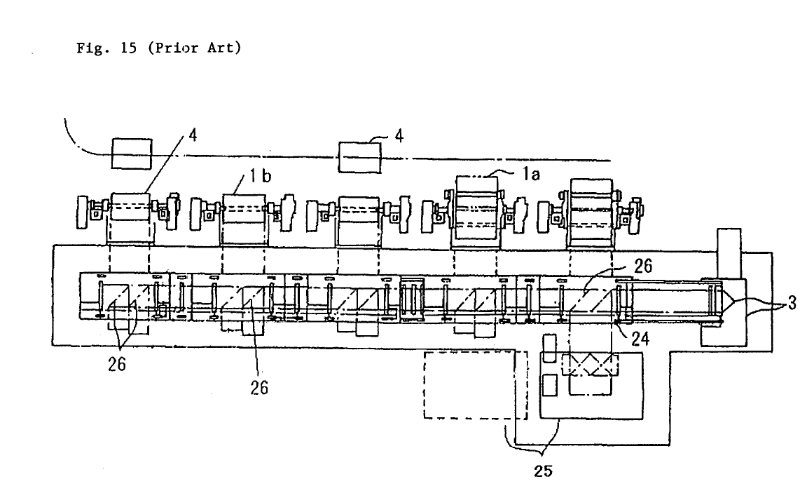

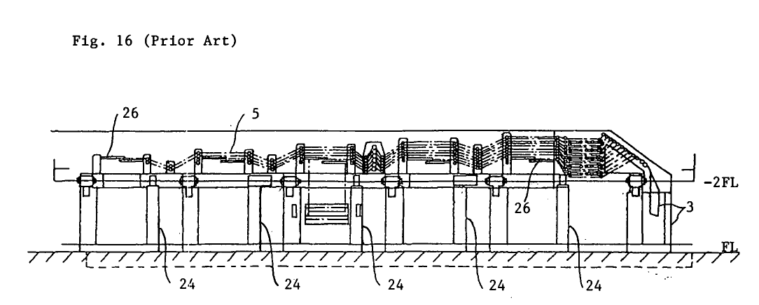

In FIG. 5, the feeding part 1a, 1b that supplies the web 5a, 5b from the paper roll 4a, 4b and the printing part 2a, 2b that performs printing of the web 5a, 5b sent from the feeding part 1a, 1b are arranged in parallel with an axial direction of the paper roll 4a, 4b, like in the second example of the prior art news rotary press shown in FIGS. 15 and 16. Also, the feeding part 1a, 1b is arranged on the same floor as the printing part 2a, 2b and/or the folding part 3 so that the feeding part 1 corresponds one to one to the printing part 2. Or a plurality of the feeding parts may be arranged so as to correspond to one printing part. As shown in FIGS. 6 and 7, printing of the web 5a, 5b unwound from the feeding part 1a, 1b is done in the printing part 2a, 2b and then the web 5a, 5b is cut along the running direction by the slitter 8 on the drag roller 9. The running direction of the web 5a, 5b is turned by an angle of 90° or approximately 90° by the turn bar 17, 18 corresponding to the web width narrower than the all-web width or the turn bar 22 corresponding to the all-web width, both provided above the printing part 2a, 2b, and the web 5a, 5b is led by the triangular former 10a, 10b so as to enter the folding part 3. As shown in FIG. 5, the folding part 3 is arranged in the same row as the printing part 2a, 2b and, like in the first embodiment, the turn bar is selected according to the web width of the web to be printed or the position adjustment is done relative to the triangular former 10a, 10b. Then, the printed object, after folded, is discharged in the arrow direction shown in FIG. 8.

1. A rotary press comprising a plurality of feeding parts supplying a web from a paper roll, a plurality of printing parts printing the web sent from said feeding parts and a folding part folding the web sent from said printing parts, wherein said rotary press further comprises a slitter cutting the web along a running direction of the web, a turn bar changing the running direction of the web before the web sent from said printing parts enters said folding part and a plurality of triangular formers leading the web to said folding part and said turn bar is selected corresponding to a web width to be printed or a position of said turn bar is adjusted relative to said triangular formers.

2. A rotary press as claimed in claim 1, wherein said turn bar comprises a turn bar corresponding to an all-web width and at least one turn bar corresponding to a web width narrower than the all-web width.

3. A rotary press as claimed in claim 1, wherein said feeding parts and said printing parts are arranged along the running direction of the web, said folding part is arranged in parallel with an axial direction of the paper roll in said feeding parts and said turn bar is provided between said printing parts and said folding part so that the running direction of the web is changed by an angle of 90° or approximately 90°.

4. A rotary press as claimed in claim 1, wherein said feeding parts are arranged on the same floor as said printing parts and/or said folding part and said turn bar is arranged above said printing parts arranged in parallel with an axial direction of the paper roll corresponding to said feeding parts so that the running direction of the web is changed by an angle of 90° or approximately 90°.

5. A rotary press as claimed in claim 2, wherein said feeding parts and said printing parts are arranged along the running direction of the web, said folding part is arranged in parallel with an axial direction of the paper roll in said feeding parts and said turn bar is provided between said printing parts and said folding part so that the running direction of the web is changed by an angle of 90° or approximately 90°.

6. A rotary press as claimed in claim 2, wherein said feeding parts are arranged on the same floor as said printing parts and/or said folding part and said turn bar is arranged above said printing parts arranged in parallel with an axial direction of the paper roll corresponding to said feeding parts so that the running direction of the web is changed by an angle of 90° or approximately 90°.
